(19) United States
(12) Patent Application Publication
(10) Pub. No.: US 2008/0023436 A1
(43) Pub. Date: Jan. 31, 2008

(54) DEPOSITION BY ADSORPTION UNDER AN ELECTRICAL FIELD

(75) Inventors: Mickael Gros-Jean, Grenoble (FR); Philippe Bouvet, Arvillard (FR)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: STMicroelectronics S.A., Montrouge (FR)

(21) Appl. No.: 11/782,796

(22) Filed: Jul. 25, 2007

(30) Foreign Application Priority Data
Jul. 27, 2006 (FR) 06/06902

(51) Int. Cl. H01G 4/002; C23C 8/06

(52) U.S. Cl. 216/6; 427/585

(57) ABSTRACT

A method for depositing a material by adsorption onto a substrate, includes a step of exposing the substrate to a precursor molecule in the gaseous phase. These precursor molecules present a non-zero dipole moment. An electrical field is applied during the substrate exposing step to cause a reactive branch of the precursor molecules to adsorb into the surface of the substrate in a manner such that the precursor molecules have essentially a same orientation. Next, the substrate is exposed to reagent molecules in the gaseous phase which react with the adsorbed precursor molecules so that organic branches of the adsorbed precursor molecules other than the reactive organic branch are replaced by elements of the reagent molecules. This process results in the formation of a monoatomic layer.

### PRIORITY CLAIM

The present application is a translation of and claims priority from French Patent Application No. 06 06902 of the same title filed Jul. 27, 2006, the disclosure of which is hereby incorporated by reference to the maximum extent allowable by law.

### BACKGROUND OF THE INVENTION

1. Technical Field of the Invention

The present invention relates to the deposition by adsorption of a material onto a substrate in a manufacturing process for a semiconductor type of product.

2. Description of Related Art

“Substrate” is understood to mean any material onto which the material is deposited. For example, in the manufacture of a 3D capacitor, the substrate comprises a layer of dielectric material in which a trench is cut, as well as any other underlying sublayers such as electrodes.

A deposition by adsorption is performed by exposing the substrate to a precursor in the gaseous phase or liquid phase. The precursor molecules are adsorbed onto the surface of the substrate. The adsorption may involve weak bonding between the adsorbed molecules and the substrate, such as Van Der Waals forces (physisorption), or chemical bonds (chemisorption).

Depositions by adsorption include such methods as chemical vapor deposition (CVD), atomic layer deposition (ALD), or plasma enhanced ALD (PEALD).

In a CVD deposition, the substrate is exposed to one or more reagents in the gaseous phase. Energy is introduced so that the reagent or reagents may form a solid. This energy may be introduced by raising the temperature, for example, or through the use of a plasma. The solid formed in this manner is adsorbed onto the surface of the substrate. Chemical reactions may possibly occur at the surface.

The principle of ALD deposition consists of alternately exposing the substrate to different precursors, so that reactions between precursors occur at the surface of the substrate. The deposition typically occurs in multiple cycles, each cycle involving the same steps. For example, as illustrated in FIGS. 1A and 1B, during a cycle, a precursor trichlorosilane or TCS (HSiCl₃) is introduced. Molecules of TCS 1 are adsorbed at the surface of the substrate 2, with the creation of a chemical bond with the substrate. After a purge step, the substrate is exposed to ammonia in gaseous form. The chemisorbed TCS molecules then react with ammonia molecules to form an atomic layer 3 of silicon nitride (Si₃N₄). During the next cycle TCS is introduced again, and so on.

In a PEALD deposition, a plasma is applied during each cycle in order to facilitate reactions between precursors. To use the above example, the exposure of the substrate to ammonia may be done by applying an ammonia plasma.

In general, the precursor molecules are adsorbed with a random orientation relative to the substrate surface. The deposited material may thus be relatively disorganized, which may affect its properties. For example, in the case of a dielectric material comprising metal or metalloid atoms, such as the silicon atoms of silicon nitride, it is possible for some of these atoms to be relatively close to each other, which may result in leakage currents.

There is a need in the art to remedy this disadvantage.

### SUMMARY OF THE INVENTION

In accordance with an embodiment, a method for the deposition by adsorption of a material onto a substrate comprises: exposing the substrate to a precursor in the gaseous phase, the molecules of the precursor presenting a non-zero dipole moment, and applying an electrical field during the exposure of the substrate to the precursor.

Thus the precursor molecules reaching the surface of the substrate have an orientation determined by their dipole moment and by the electrical field to which they are subjected, such that the material so deposited is relatively organized. This avoids any effect on the properties of the deposited material due to an adsorption with a random orientation.

In addition, the adsorption is performed in a relatively orderly manner, because the molecules are not randomly oriented. The deposition rate is therefore relatively high.

Such control of the orientation of molecules during adsorption allows for controlling certain parameters of the deposited layer, such as the density, structure, dielectric constant, and other physical and chemical properties.

For precursor molecules which are electrically neutral overall, the electrical field does not accelerate these molecules, but simply orients them.

Conventionally, during the exposure step, the precursor molecules are in the gaseous phase.

The precursor molecules have the same orientation and come in contact with the substrate with the same branch, called the leading branch. By choosing precursor molecules such that the leading branch tends to form bonds, one further increases the effectiveness of the adsorption and therefore the deposition rate. For example, one may choose a leading branch which tends to form weak bonds, or a relatively reactive leading branch, particularly for ALD depositions.

Of course, the method is not limited by the order in which the exposure and application steps are performed, as long as an electrical field is applied for at least a part of the exposure. The electrical field may be applied prior to the exposure to the precursor, for example, and cut off during the exposure or afterwards. Alternatively, the electrical field may be applied after introduction of the precursor into a chamber, and cut off during or after the exposure.

Typically, the electrical field is relatively uniform over the surface of the substrate. However, one may have an electrical field presenting variations in direction and/or intensity on the surface of the substrate.

Typically, the electrical field remains constant in direction and intensity for the duration of the step when the electrical field is applied. However, one may have an electrical field with an intensity and/or direction which varies over the course of the application step.

The dipole moment may be permanent, or induced by the applied electrical field.

It is advantageous to apply the electrical field in an essentially constant manner for the duration of the exposure step. In this manner, the orientation of the precursor molecules is imposed by the electrical field for the entire duration of the exposure, avoiding adsorptions of molecules with a random orientation.

Alternatively, the electrical field may be applied in a sequential manner only, for example during at least a part of the exposure step, for example at the start of the exposure, particularly if one wishes to obtain a relatively disorganized layer of material.

The process for the deposition by adsorption may be a CVD, ALD, or PEALD process, or some other process.

In particular, after the exposure to precursor step and after a possible purge step, the process may comprise a step involving an exposure to reagent molecules in the gaseous phase in order to achieve a reaction with the adsorbed precursor molecules. For example, the reagent molecules may comprise molecules of dioxygen or ammonia in the gaseous phase, in order to lead to an oxidation or nitriding reaction respectively.

Such a step is not required. For example, in the case of a CVD deposition, the adsorbed molecules may react by themselves, or not react at all after adsorption.

The substrate may present variations in the contours of the surface, particularly in the context of manufacturing a 3D capacitor, for analog, radiofrequency, or decoupling technologies for example, in the context of DRAM (Dynamic Random Access Memory) memory or in the context of gate dielectrics.

Alternatively, the substrate may have a flat surface.

The precursor molecules may comprise at least one inert branch, meaning in this context that it has no tendency to form bonds with the substrate. For example, one may choose a branch which is non-reactive with the substrate. This reinforces the organization of the deposited material. If some precursor molecules come in contact with the substrate by this inert branch, the inert branch does not tend to form a bond with the substrate. The layer of material obtained in this manner is such that a relatively high proportion of molecules directly adsorbed onto the substrate present essentially the same orientation.

In particular, in the case of a material presenting a surface with variations in the contour, one or more inert branches allow performing a selective deposition. Due to the electrical field, the molecules come in contact with certain zones by their inert branch and form few or no bonds with the substrate. The only areas covered by a thin layer of material are those areas presenting a slope such that the precursor molecules arrive in a grouping which tends to form bonds. A relatively selective deposition by adsorption may be achieved in this manner.

For example, in the manufacture of a 3D capacitor, the surface of the substrate may present a trench. The exposure to the precursor molecules step is performed in this example under an electrical field, such that the precursor molecules are adsorbed selectively onto the walls of the trench: for example, for precursor molecules presenting two reactive branches along the axis of the dipole moment, an electrical field is chosen which is perpendicular to the walls of the trench. For precursor molecules presenting two inert branches along the axis of the dipole moment, an electrical field is chosen which is roughly parallel to the walls of the trench. In this example, the exposure to the precursor molecules step leads to the formation of a first metallic layer, and the following steps are performed: deposition of a second layer of a dielectric material, deposition of a third metallic layer, polishing operation to level the surface of the substrate or etching operation to define a capacitor.

Thus the first layer is only adsorbed onto the vertical walls of the trench.

It is known to deposit these three layers on the entire surface of the substrate, without any particular selectivity, and then to perform a CMP polishing operation (Chemical Mechanical Polishing). However, as the first layer is metal, the polishing operation could lead to metal burrs on the surface.

Limiting the adsorption of the first metallic layer to the vertical walls of the trench thus avoids deterioration in the performance of the 3D capacitor.

In an embodiment, a method for depositing by adsorption a material onto a substrate comprises: exposing the substrate to precursor molecules in the gaseous phase, these precursor molecules presenting a permanent dipole moment and each having an organic branch which is reactive and aligned with the dipole; applying a electrical field oriented perpendicular to a surface of the substrate to which the precursor molecules are adsorbed through contact with the reactive organic branches.

In another embodiment, a method comprises: forming a trench in a substrate, the trench having opposed vertical walls and a floor; exposing the substrate to precursor molecules in the gaseous phase, these precursor molecules presenting a permanent dipole moment and each having an organic branch which is reactive and aligned with the dipole; applying a electrical field oriented perpendicular to the vertical walls of the trench so that the precursor molecules are adsorbed to the vertical walls through contact with the reactive organic branches.

### BRIEF DESCRIPTION OF THE DRAWINGS

Other features and advantages will become apparent upon reading the description that follows the description hereinbelow of a non-limiting exemplary embodiment(s), making reference to the appended drawings, in which:

FIGS. 1A and 1B, already discussed, illustrate an example of a known process of deposition by adsorption;

FIGS. 2A and 2B illustrate an example of a deposition by adsorption process according to one embodiment of the invention;

FIG. 3 shows an example of a deposition in one embodiment of the invention;

FIG. 4 shows another example of a deposition in one embodiment of the invention;

FIGS. 5A to 5D illustrate an example of a deposition process in one embodiment of the invention; and

FIG. 6 shows an example of a system for applying an electrical field for a deposition process in one embodiment of the invention.

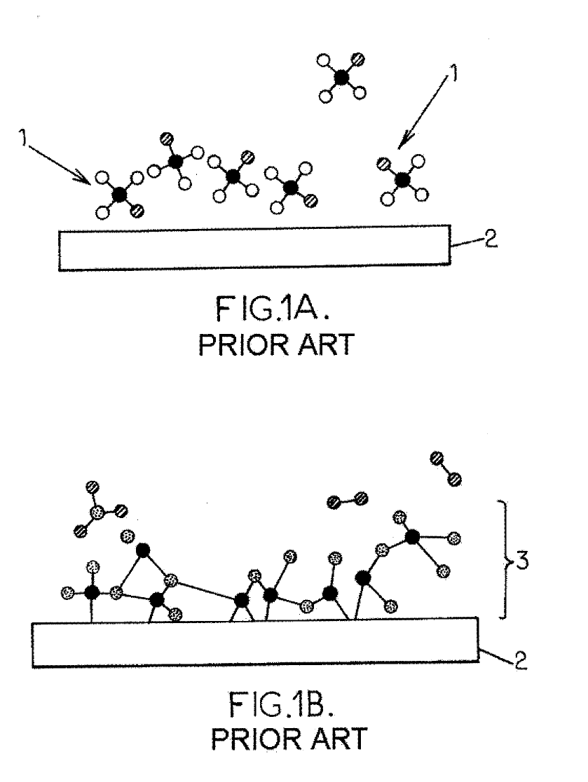

### DETAILED DESCRIPTION OF THE DRAWINGS

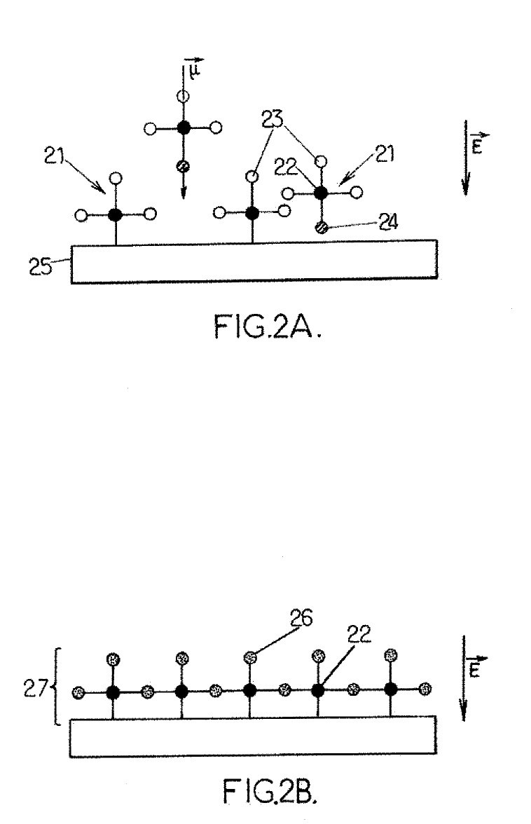

The embodiment illustrated by FIGS. 2A and 2B uses a PEALD process. Precursor molecules, for example molecules of Tert-Butylimido-Tris(Diethylamido) Tantalum (TBTDET), are introduced in gaseous form into a reaction chamber so that a part of these molecules is adsorbed onto the surface of a substrate 25.

A TBTDET molecule comprises four groups 23, 24 around a tantalum atom 22, of which one organic branch 24 differs from the other branches 23. The TBTDET molecules have a permanent dipole moment.

Although represented as a flat plane, the TBTDET molecules in reality extend in three dimensions.

The substrate 25 may, for example, comprise a layer of a dielectric material.

A continuous electrical field is applied for the entire duration of the exposure of the substrate to TBTDET. As an example, one may apply voltage of between about 1V and 25V between two electrodes separated for example by 1 centimeter. The electrical field may be a permanent field or may be applied in an essentially sequential manner during one of the deposition steps, for example, in the case of an ALD deposition, the exposure to the metal precursor step.

Thus it is a Tert-Butylimido branch 24 of the molecules which comes in contact with the substrate in the adsorption, so the molecules present the same orientation. It is this branch 24 of the TBTDET molecules which reacts in the adsorption.

Next the substrate is exposed to reagent molecules in the gaseous phase to achieve a reaction with the adsorbed precursor molecules. For example, a plasma of dioxygen is applied in order to oxidize the adsorbed molecules. The Diethylamido branches 23 are replaced in this manner with oxygen branches 26, forming a layer 27 of Ta₂O₅.

It is advantageous to perform this exposure to reagent gas-phase molecules under relatively mild conditions to avoid changing the orientation of the adsorbed molecules. In this example, relatively mild oxidation conditions are chosen, typically a plasma of relatively low density. For this purpose, a relatively high pressure and a relatively low radiofrequency power may be chosen for example. For example, the pressure of the chamber during application of the plasma may be between about 133 Pa and 2260 Pa, and the applied radiofrequency power density may be between 10 mW and 5 W per square centimeter of electrode.

The monoatomic layer 27 formed in this manner comprises adsorbed molecules of essentially the same orientation.

The PEALD deposition is performed in several cycles, with each cycle comprising a step of exposure to TBTDET under an electrical field and an oxidation step, such that a layer of material is formed by superimposing monoatomic layers.

The cycles may additionally comprise at least one purge step. For example, a purge may be done between the exposure to the precursor step and the application of a plasma step, in order to essentially empty the chamber of the TBTDET precursor. This avoids reactions between oxygen and the precursor other than at the surface at the substrate, as these reactions may result in the formation of undesirable particles.

A purge may also be done at the end of the cycle, before introducing the precursor into the chamber at the next cycle, in order to ensure that no plasma remains in the chamber. This purge may, for example, last several tenths of a second or even several seconds.

Alternatively, no purge step is performed, to allow a relatively fast deposition.

In another alternative a partial purge is done. For example, the precursor is mostly evacuated, typically so that the partial pressure of the remaining precursor is below a threshold above which the precursor reacts in volume with oxygen when a given plasma is applied. This threshold therefore largely depends on the deposition conditions. By “reaction in volume,” it is meant a reaction other than at the surface of the substrate, meaning a reaction of non-chemisorbed molecules.

In another example, it is the oxygen in plasma form which is mostly evacuated, in order to avoid reactions in volume with the TBTDET precursor.

A partial purge avoids the formation of undesirable particles, while limiting the slowing of the process.

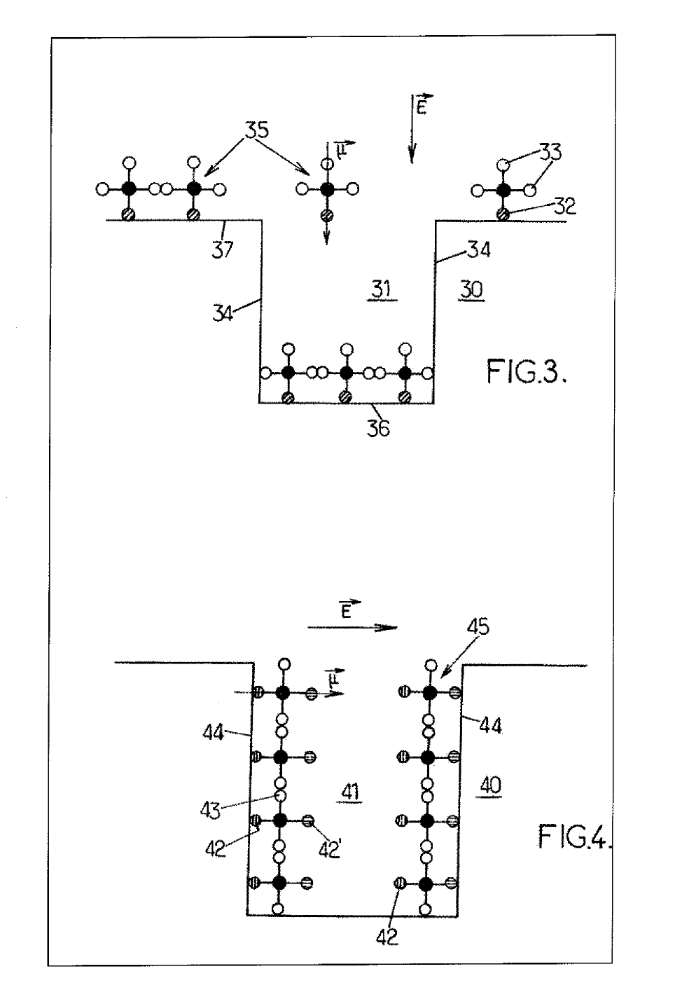

FIG. 3 shows an example of deposition in one embodiment of the invention. In this embodiment, the surface of the substrate 30 presents variations in its contours, for example the trench 31 shown here.

The precursor molecules 35 are chosen to have a branch 32 which is different from the other branches 33, such that they present a permanent dipole moment. The different branch 32 is chosen to be considerably more reactive than the other branches 33. The other branches 33 are considered to be inert in comparison.

An electrical field essentially parallel to the walls 34 of the trench 31, called a vertical electrical field, is applied. The electrical field orients the precursor molecules 35 in a same direction.

The sign of the electrical field is chosen such that if a molecule 35 is deposited on the bottom of the trench 36, it is by the branch 32. The molecules 35 are thus adsorbed onto the bottom of the trench 36, as well as onto the trench edges 37. However, if a molecule 35 comes in contact with a wall 34 of the trench, it is by an inert branch 33, such that the molecule 35 has relatively little tendency to be adsorbed onto the wall 34.

In this manner a relatively selective deposition by adsorption is obtained.

FIG. 4 shows another example of a selective deposition. In this embodiment as well, the substrate 40 comprises a trench 41.

The precursor molecules 45 comprise four branches 42, 42′, 43, where two organic branches 42, 42′ differ from the other branches 43. In this example, the branches 42, 42′ are more reactive than the branches 43, called the inert branches, and the precursor molecules 45 present a dipole moment between these branches 42, 42′.

By applying an electrical field perpendicular to the walls 44 of the trench 41, one may achieve a selective deposition of molecules 45 onto the walls 44.

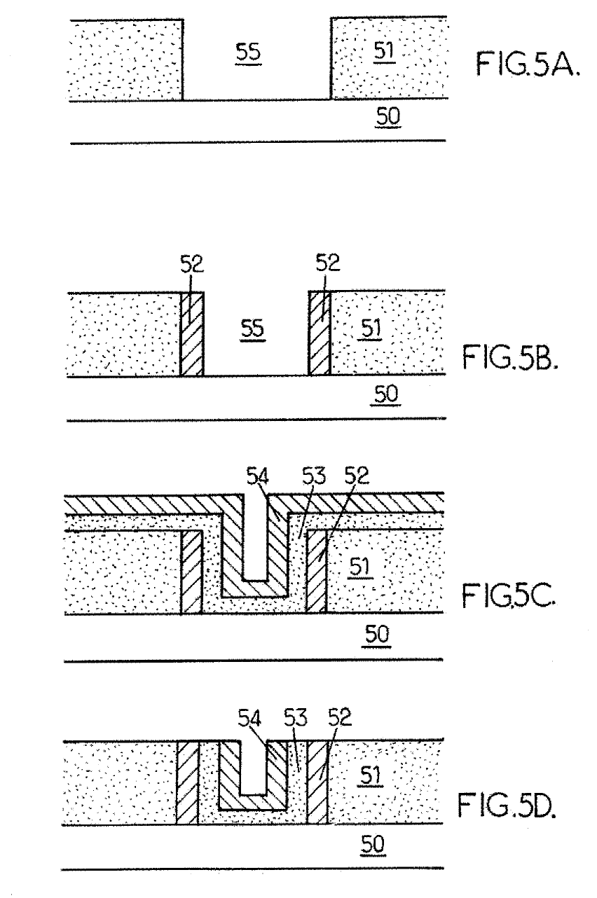

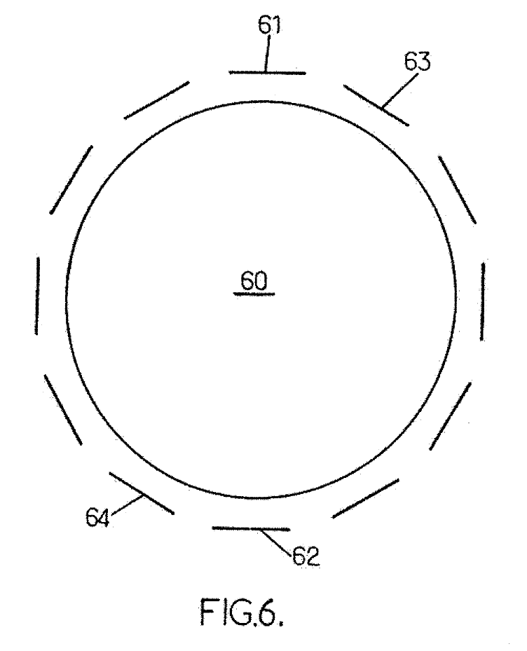

The process for manufacturing a 3D capacitor illustrated by FIGS. 5A to 5D is based on such a selective deposition onto the trench walls. In this example, the substrate comprises a metal line 50 and a relatively thick layer of insulating oxide 51 in which a trench 55 is made.

A selective deposition is performed of a first layer 52 onto the walls of the trench 55, as illustrated in FIG. 5B. This deposition is performed by applying an electrical field during the exposure of the substrate to precursor molecules. The process illustrated by FIG. 4 may be performed, for example.

The first layer 52 is a metallic layer.

Next a second layer 53 and a third layer 54 are successively deposited, using a conventional and non-selective process, as illustrated in FIG. 5C.

The second layer 53 is a layer of a dielectric material, and the third layer 54 is a metallic layer.

The first layer 52 and the third layer 54 in fact form two electrodes of the 3D capacitor.

A polishing operation or CMP is then performed in order to level the surface of the substrate, as illustrated in FIG. 5D. As the first layer 52 was selectively deposited onto the walls of the trench 55, the polishing does not result in metal burrs on the polished surface.

FIG. 6 shows an example of a system for applying an electrical field roughly parallel to the substrate 60, and rotating.

During a first period of time, a potential difference is applied between electrodes 61 and 62, creating an electrical field. Then the potential difference between these electrodes 61, 62 is returned to zero, while a potential difference is applied between electrodes 63 and 64 during a second period, creating an electrical field which is slightly offset from the electrical field created during the first period. Continuing in this manner, one may generate a rotating electrical field.

A rotating electrical field allows adsorption of precursor molecules onto surfaces perpendicular to a substrate plane but not parallel to each other, for example the walls of two trenches which run in two different directions.

Variants

The invention is not limited by the number of branches of the precursor molecules. One may have presursors with one, two, three, four, five, or more branches.

Although preferred embodiments of the method and apparatus have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for depositing by adsorption a material onto a substrate, comprising:
exposing the substrate to a precursor in the gaseous phase, with the precursor molecules presenting a non-zero dipole moment, and
applying an electrical field during substrate exposing so as to adsorb precursor molecules onto the substrate.

2. The deposition method according to claim 1, wherein the electrical field is applied in a continuous or sequential manner essentially for the duration of substrate exposing.

3. The deposition method according to claim 1, further comprising exposing to reagent molecules in the gaseous phase in order to achieve a reaction with the adsorbed precursor molecules.

4. The deposition method according to claim 1, wherein the precursor molecules comprise TBTDET molecules.

5. The deposition method according to claim 1, wherein the surface of the substrate presents variations in contour.

6. The deposition method according to claim 5, wherein the precursor molecules comprise at least one inert branch.

7. The deposition method according to claim 1, wherein the surface of the substrate presents a trench, and wherein exposing to precursor molecules is performed under an electrical field such that the precursor molecules are selectively adsorbed onto the walls of the trench so as to deposit a first metallic layer, and further comprising:
depositing a second layer of a dielectric material,
depositing a third metallic layer,
performing a polishing operation to level the surface of the substrate or an etching operation to define a capacitor.

8. A method for depositing by adsorption a material onto a substrate, comprising:
exposing the substrate to precursor molecules in the gaseous phase, these precursor molecules presenting a dipole moment and each having an organic branch which is reactive and aligned with the dipole;
applying an electrical field oriented perpendicular to a surface of the substrate to which the precursor molecules are adsorbed through contact with the reactive organic branches.

9. The method of claim 8 further comprising exposing the substrate to reagent molecules in the gaseous phase which react with the adsorbed precursor molecules.

10. The method of claim 9 wherein organic branches of the adsorbed precursor molecules other than the reactive organic branch are replaced by elements of the reagent molecules.

11. The method of claim 9 wherein each cycle of exposing, applying and exposing forms a monoatomic layer of adsorbed molecules having essentially a same orientation.

12. The method of claim 8, wherein the precursor molecules comprise TBTDET molecules and the reagent molecules comprise dioxygen to form a monoatomic layer of Ta₂O₅.

13. The method according to claim 8, wherein the surface of the substrate presents variations in contour.

14. The method according to claim 13, wherein the variation in contour is a formed by a trench having opposed vertical walls and a floor, and wherein applying an electrical field comprises applying that field oriented perpendicular to the opposed vertical walls.

15. The method according to claim 13, wherein the precursor molecules comprise at least one inert branch.

16. A method, comprising:
forming a trench in a substrate, the trench having opposed vertical walls and a floor;
exposing the substrate to precursor molecules in the gaseous phase, these precursor molecules presenting a dipole moment and each having an organic branch which is reactive and aligned with the dipole;
applying a electrical field oriented perpendicular to the vertical walls of the trench so that the precursor molecules are adsorbed to the vertical walls through contact with the reactive organic branches.

17. The method of claim 16 further comprising exposing the substrate to reagent molecules in the gaseous phase which react with the adsorbed precursor molecules so that organic branches of the adsorbed precursor molecules other than the reactive organic branch are replaced by elements of the reagent molecules to form a first metal layer of a capacitor.

18. The method of claim 17 wherein the adsorbed precursor molecules on the vertical walls form at least one monoatomic layer of adsorbed molecules having essentially a same orientation.

19. The method of claim 17 further comprising depositing an insulating layer over the first metal layer in the trench and the floor of the trench.

20. The method of claim 19 further comprising depositing a second metal layer in the trench over the insulating layer, the first and second metal layers forming electrodes of a capacitor.
